(19) United States
(12) Patent Application Publication
(10) Pub. No.: US 2006/0233675 A1
(43) Pub. Date: Oct. 19, 2006

(54) Glass test tube having protective outer shield

(76) Inventor: Israel Mayer Stein, Chestnut Hill, MA (US)

Correspondence Address: Kenneth J. LuKacher, South Winton Court, 3136 Winton Road South, Suite 204, Rochester, NY, 14623, US

(21) Appl. No.: 11/104,927

(22) Filed: Apr. 13, 2005

(51) Int. Cl. B01L 9/00

(52) U.S. Cl. 422/102

(57) ABSTRACT

An improved glass test tube is provided with a protective shield on the test tube's outer surface which protects the test tube from accidental breakage. The protective shield may be of a color which indicates that it has breakage protection. In one embodiment, the protective shield is provided by plastic material which is coated or sprayed on the outer surface of the glass test tube. In another embodiment, the protective shield is provided by one or more layers of wrapped sheet material, such as polyester film. The improved glass test tube is particularly useful in automatic analyzers that measure erythrocyte sedimentation rate.

### FIELD OF THE INVENTION

The present invention relates to a glass test tube having a protective shield, and particularly, to a glass test tube having a protective shield of a material on the tube's outer surface which protects the test tube from accidental breakage. Such outer shield may be of a color indicating that the test tube has such breakage protection. The present invention is especially useful for glass test tubes which are traditionally use in automatic analyzers of medical specimens.

### BACKGROUND OF THE INVENTION

Automatic analyzers and test equipment for measuring erythrocyte sedimentation rate (ESR) of blood are conventionally used in medical laboratories and physician offices. ESR represents the rate red blood cells fall in a period of time, and is often used by physicians in evaluating patient health. Blood is tested in such analyzers is a test tube sealed by a stopper with an anticoagulant. For more information on ESR Testing, see Methods for the Erythrocyte Sedimentation Rate (ESR) Test—Third Edition; Approved Standard, NCCLS Document H2-A3, Vol. 13, No. 8, August 1993. Such analyzers and equipment have optical sensors for reading specimens contained in test tubes. For example, automatic ESR analyzers are sold by Clinical Data, Inc. of Newton, Mass.

Test tubes for ESR testing are preferably made of glass, since the test was developed using glass test tubes and thus are needed to maintain classical reliance on ESR readings by physicians. As a result, glass test tubes are widely used in ESR testing. One problem with glass tubes is that they are prone to accidental breakage if dropped or otherwise mishandled by technicians. This can be especially concerning to technicians handling possible biohazardous blood. Although plastic test tubes have been developed which are not prone to accidental breakage, they are disfavored for ESR testing since they are not of glass. Thus, it would be desirable to provide a glass test tube which has the protection from breakage usually associated with plastic test tubes. Further, it would be desirable if such glass test tube were distinguishable from typical glass test tubes which lack such protection.

### SUMMARY OF THE INVENTION

Accordingly, it is the principal feature of the present invention to provide an improved glass test tube with a protective outer shield of a material that protects the glass test tube from accidental breakage.

It is another feature of the present invention to provide an improved glass test tube having a protective outer shield of a color which indicates that it has breakage protection.

It is a further object of the present invention to provide an improved glass test tube with a shield material having an outer diameter suitable for loading such test tube into slots of automatic testing equipment.

Briefly described, the test tube embodying the present invention has a glass tube with an open end and dome shaped closed end, and protective material covering the outer surface of the glass tube with or without the protective material covering the closed end.

In one embodiment, the protective material represents a plastic layer of vinyl, or other plastic material, coated or sprayed on the outer surface of the glass tube.

In another embodiment, the protective material represents one or more layers of wrapped sheet material, such as polyester film. For example, such polyester film may be a sheet of Mylar, a polyethyleneterephthalate (PET), available from E. I. Du Pont de Demours and Company.

The protective material may be transparent, or of a color which indicates that the test tube has breakage protection.

### DETAILED DESCRIPTION OF THE DRAWINGS

The foregoing and other objects, features, and advantages of the invention will become more apparent from a reading the following detailed description in connection with the accompanying drawings in which:

FIG. 1 is a side view of the glass test tube in accordance with the present invention in which the shield material is shown over the entire outer surface of the test tube; and

FIG. 1A is another side view similar to FIG. 1 in which the shield material is shown over the test tube without such material covering the dome of the closed end;

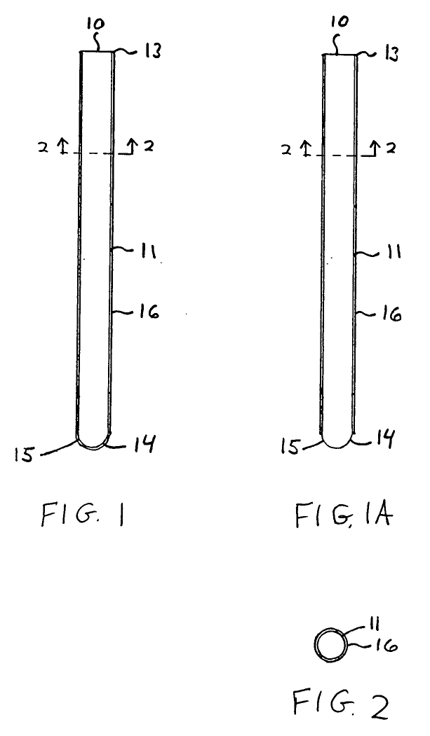

FIG. 2 is a cross sectional view of the glass test tube of FIGS. 1 or 1A along lines 2-2; and

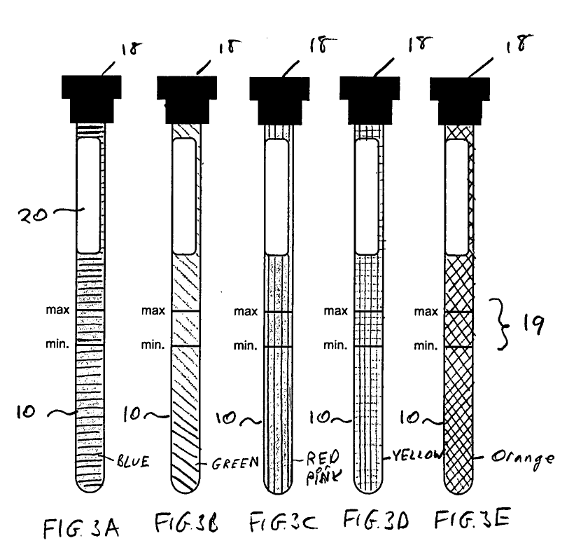

FIGS. 3A-3E are side views, similar to FIG. 1 with five examples of different color of shield material, e.g., blue (FIG. 3A), green (FIG. 3B), red or pink (FIG. 3C), yellow (FIG. 3D), and orange (FIG. 3E).

### DETAILED DESCRIPTION OF THE INVENTION

Referring to FIG. 1, a test tube 10 is shown having a hollow, cylindrical portion 11 with an open end 13 and a closed dome shaped end 14, and protective shield material 16 over the outer surface of cylinder portion 11 and the closed end 14. The cylindrical portion 11 with closed end 14 represents a typical glass test tube 15, such as used for containing blood or other bodily fluid specimen of a patient, upon which material 16 is applied.

Optionally, the protective material 16 may extend over cylinder portion 11 without covering closed end 14, as shown in FIG. 1A. This may be acceptable since the closed end 14 is often the thickest part of a glass test tube, and as such already provides a level of protection from breakage about end 14. A cross-section of the test tube 10 of FIGS. 1 and 1A is shown in FIG. 2.

Test tube 10 is insertable into a slot of an automatic analyzer for optically measuring contents when contained in the test tube. For example, such automatic analyzer may provide for ESR measurements. Protective material 16 enables light or other radiation, such as IR, used by automatic analyzers and test equipment to pass there through to analyze the contents of the test tube 10. However, the amount of such light may be reduced by material 16, but is still sufficient to enable proper performance of the automatic analyzer. The thickness of material 16 is such that it adds to the outer diameter of cylindrical portion 11, but still permits proper insertion of the test tube 10 into slot(s) of automatic analyzers and test equipment, such as ESR analyzers available from Clinical Data, Inc.

The material 16 may be transparent, or may instead be of color, such as red or blue, to indicate that such test tube 10 has protective material 16, distinguishing the test tube 10 from an unprotected test tube. The addition of color to material 16 can be useful since material 16 if transparent may not be noticeable to the user, and thus the presence of a color assures that the user will select the glass tube with the protection from accidental breakage provided by material 16. Glass test tube 10 with five different colors of material 16 is shown for example in FIGS. 3A-3E. In FIGS. 3A-3E, each test tube 10 is shown with a stopper 18 inserted into open end 13, two lines indicating minimum and maximum levels 19 of contents when contained in an upright tube, and a label 20 for identifying the patient and/or test.

In one embodiment, protective material 16 represents a layer of plastic material over cylindrical portion 11 and closed end 14. Such plastic material may be of vinyl, or other plastic material, coated or sprayed on the outer surface of the glass test tube. Preferably, the plastic material is Plastisol, a vinyl compound. To apply the Plastisol, the glass tube 15 once heated is dipped closed end first into heated Plastisol to coat tube 15, and then removed to cure the Plastisol which binds onto the outer surface of the glass of tube 15. Control of temperatures and dip time determines the thickness (or amount) of Plastisol applied. The coating is sufficiently thick to provide adequate protection to the glass tube from breaking if accidentally dropped. For example, the thickness may be about 0.05 to 0.1 millimeters thick or less, but other thicknesses may be used, as desired. Once cured, excess material 16 may be cut away from open end 13, if needed, to provide test tube 10 of FIG. 1. Also, if needed for use in automatic testing equipment or otherwise, the material 16 may be cut away from closed end 14 to provide the test tube of FIG. 1A. Alternatively, the plastic material may be spray coated onto the glass tube. If desired, color additive(s) may be provided to the plastic material prior to application to the test tube to provide color to material 16 as described earlier.

In another embodiment, the protective material 16 represents one or more layers of wrapped sheet material, such as polyester film. For example, such polyester film may be a sheet of Mylar, a polyethyleneterephthalate (PET), available from E. I. Du Pont de Demours and Company. The Mylar sheet may be wrapped around the test tube until the desired thickness is reached. The sheet wrapped may have an adhesive layer which contacts the outer surface of cylindrical portion 11 to adhere the sheet to the outer surface of the glass tube, and then to the outer surface of the wrapped sheet. If needed, excess Mylar may be cut away from open end 13. The resulting test tube 10 is shown, for example, in FIG. 1A. The process for wrapping Mylar sheets onto thin pipette tubing is described in U.S. Pat. Nos. 5,900,091 and 5,173,266. Unlike the pipettes made by these patents in which the entire surface of the pipette is wrapped, the test tube 10 is much larger in diameter, e.g., 8 to 10 millimeters in diameter, and has a closed end which is not covered the Mylar. If desired, color additive(s) may be provided to the Mylar sheet when manufactured, such that the material 16 has the appearance of color, as described earlier.

From the foregoing description, it will be apparent that there has been provided an improved glass test tube having a protective outer shield from glass breakage. Variations and modifications in the herein described test tube in accordance with the invention will undoubtedly suggest themselves to those skilled in the art. Accordingly the foregoing description should be taken as illustrative and not in a limiting sense.

1. A test tube having a protective shield comprising:
a glass tube with an open end, and dome shaped closed end; and
protective material on the outer surface of the glass tube to protect the test tube from accidental breakage.

2. The test tube according to claim 1 wherein said protective material is of a color.

3. The test tube according to claim 1 wherein said protective material is transparent.

4. The test tube according to claim 1 wherein said protective material is of a plastic material coated onto the glass tube.

5. The test tube according to claim 4 wherein said plastic material is a vinyl compound.

6. The test tube according to claim 1 wherein said protective material is one or more layers of polyester sheet material.

7. The test tube according to claim 6 wherein said sheet material has an adhesive layer enabling said sheet to adhere to the outer surface of the glass tube and outer surface of said sheet when wrapped around said glass tube.

8. The test tube according to claim 1 wherein said protective material is limited to the outer surface of said glass tube outside said closed end.

9. The test tube according to claim 1 wherein said test tube is insertable into a slot of an automatic analyzer for optically measuring contents when contained in the test tube.

10. The test tube according to claim 9 wherein said analyzer provides ESR measurements.

11. A glass test tube having an outer surface comprising:
material upon the outer surface which protect the glass test tube for accidental breakage, said material being of a color indicative of the presence of said test tube having protection from accidental breakage.

12. The glass test tube according to claim 11 wherein said outer surface with said material provides an outer diameter enabling placement in an automatic analyzer.

13. The glass test tube according to claim 12 wherein said automatic analyzer provides ESR measurements.
